(19) United States
(12) Patent Application Publication
(10) Pub. No.: US 2007/0074142 A1
(43) Pub. Date: Mar. 29, 2007

(54) Integrated circuit layout methods

(75) Inventors: Michael C. Smayling, Fremont, CA (US); Michael P. Duane, Santa Clara, CA (US)

Correspondence Address: PATENT COUNSEL;APPLIED MATERIALS, INC., Legal Affairs Department, P.O. Box 450A, Santa Clara, CA, 95052, US

(73) Assignee: Applied Materials, Inc.

(21) Appl. No.: 11/235,964

(22) Filed: Sep. 27, 2005

(51) Int. Cl. G06F 17/50

(52) U.S. Cl. 716/21; 716/8

(57) ABSTRACT

The present invention provides methods of post-layout processing, such as OPC post-processing, through partitioning of integrated circuit data files. Partitioning methods of the present invention comprise forming partitioned identical cell groups. Each partitioned identical cell group comprises identical cells such that the cells within a partitioned group include identical cell data file components and identical cell proximity layout patterns. The partitioned cells of an identical cell group are then subjected to OPC post-processing. Non-partitioned cells can be subjected to OPC post-processing separately. In another method of the present invention an integrated circuit data file including at least one diagonal line, is rotated to obtain a rectilinear orientation of the line that was originally in a diagonal orientation. The line is subjected to OPC post-processing while in the rectilinear position. Thereafter, the data file is rotated in order to return the line to its original diagonal position.

### FIELD OF THE INVENTION

The present invention relates to methods for preparing integrated circuit mask layout data files, and particularly to methods regarding post-layout processing techniques.

### BACKGROUND OF THE INVENTION

A typical integrated circuit (IC) chip layout is prepared by employing a CAD (computer-aided design) tool to place and route cells from a library of cells and custom circuit blocks to form a complete chip layout. The internal layout data base is converted to a standard stream data file format such as GDS-II, for mask making. GDS-II is available from Cadence Design Systems, located in San Jose, Calif.

Typically, an IC chip includes a semiconductor substrate and several layers that are sequentially deposited on the substrate. The CAD layout that includes the IC elements, including the library cells of a chip layer, is commonly referred to as a composite layout. A separate CAD layout is utilized to prepare a reticle/mask of the circuit pattern for each chip layer, employing conventional photolithography techniques. The CAD data format is translated to a mask writer data format in a process referred to as fracturing, wherein the CAD layout features are fractured into exposure specific data. The fractured data form the reticle mask data file. This data file is then employed to project an image of the layout on a photoresist covered reticle blank, in a process known as mask writing. Typically, mask writing requires a significant write-time due to the complexities and volume of the fractured data.

Imaging of the layout, i.e. exposure of the blank, is generally executed using laser or e-beam technology. The exposed blank is subsequently developed, and etched to fabricate a reticle/mask having the circuit pattern that includes all of the required circuit elements for a particular chip layer. A typical reticle includes a glass plate having transparent and opaque regions, usually chromium, that form the IC pattern for the chip layer.

Using conventional lithography, the mask or reticle is used to project the IC pattern on a photoresist layer that is deposited on a chip layer, such as a dielectric layer. The exposed resist layer is then developed to expose areas of the chip layer that are intended to be treated or to be selectively protected, such as selectively etching a dielectric layer in order to form cavities for the subsequent fabrication of electrical contacts, vias and interconnect lines in or on the dielectric layer, or to selective etch or protect exposure patterns of silicon in a substrate or polysilicon on a wafer substrate and to for example fabricate gate electrodes for transistors.

Currently, wafer fabrication manufacturing techniques employ greatly reduced IC design geometries, complex patterns and reduced interconnect diameter and/or length. These techniques have demonstrated the critical importance of proximity effects. Proximity effects are observed in imaged patterns that are in very close proximity to each other, such that the closely positioned patterns cause image pattern distortion, thereby resulting in a photoresist pattern that is significantly different from the intended design, or that fails to meet the circuit density or CD (critical dimension) requirements. Also, proximity effects can for example be prominent when the CD of a design feature is near or below the wavelength of the radiation that is used to project the mask image on a photoresist layer. Several causes for proximity effects have been identified. These include lithography radiation diffraction that is caused by a boundary or edge of a reticle feature, close proximity of layout features, limited resolution of the radiation exposure, backscattering from a resist substrate such as a dielectric layer and localized resist heating.

Various techniques are utilized to correct optical proximity effects by means of post-layout processing (post-processing) methods such as optical proximity correction (OPC), in order to overcome the pattern distortion. OPC techniques involve executing the necessary changes in the chip CAD layout that is utilized to prepare the reticle. Typical OPC techniques include manual OPC and automated OPC. Automated OPC techniques include model-based OPC and rule-based OPC, see for example U.S. Pat. No. 6,467,076 (Cobb, 2002). In model-based OPC, a circuit simulation of the CAD layout is executed to determine and, if necessary, correct distortions such as in the line fragments or the line widths. Typically, the simulations and corrections need to be repeated in order to meet the design criteria. In rule-based OPC, the CAD layout is analyzed automatically for particular design features that are known to usually cause a proximity effect, such as a certain spacing distance between parallel interconnect lines, or certain line ends. The CAD layout is then automatically corrected to compensate for this feature. As disclosed by Cobb in the '076 patent, it is also known to potentially obtain significant OPC time savings by selectively applying OPC on tagged edge fragments, i.e. edge features in the layout that are of particular OPC interest. Manual or automatic corrections include for example the use of biasing techniques such as using positive or negative serifs to compensate for undesirable corner rounding and hammerheads to compensate for undesirable line shortening or corner rounding. OPC technology can be characterized as one-dimensional, for example when correcting for line width distortion, or two-dimensional when for example correcting for corner rounding. The corrections are made on individual features of the chip CAD layout in a global or macro sense, i.e. each desired correction is made in a particular feature as part of the entire chip layout or as part of a major CAD layout segment of the entire chip layout. Examples of major CAD layout segments include floor planning, block placement and the CAD layout for a specific IC chip layer.

The process of preparing a mask data file for an IC chip layout requires several processing steps. Typically, one or more verification steps are employed at intermediate stages of this process in order to determine if the software constitutes the required replication of the IC chip circuit layout

A conventional GDS-II format stream data file for mask fabricating was employed to fabricate a layout pattern (not shown) for fabricating an IC mask (not shown). The data file was then subjected to conventional OPC, resulting in IC layout sample pattern 100 shown in FIG. 1, providing a schematic representation of an exemplary portion of the GDS-II format stream data file.

Sample layout pattern 100, see FIG. 1, includes typical interconnect lines. Interconnect line 102 provides an example of a power line, while interconnect lines 104, 106, 108, 110, 112, 114 and 116 are typical of IC signal lines. Additional interconnect lines include lines 120a, 120b, 120c and 120d, each having conventional hammerheads H1, H2, H3, H4, H5, H6, H7 and H8 respectively. It is noted that interconnect line 104 includes a conventional hammerhead H9. Additional interconnect lines include lines 130a, 130b, 130c, 130d, 130e, 130f, 130g, 130h and 130i, including conventional hammerheads H10a-H10r respectively. Furthermore, sample layout pattern 100 (FIG. 1) includes interconnect lines 140a, 140b, 140c, 140d, 140e, 140f, 140g, 140h and 140i, comprising conventional hammerheads H12a-H12r respectively. Hammerheads as shown in FIG. 1 are the result of the OPC post-processing treatment of the GDS-II format stream data file. These hammerheads are typically employed to correct for optical proximity distortions that occur at the end of an interconnect line. OPC modifications such as hammerheads are utilized in the mask data file. These corrections are then replicated in the reticle, but they are not present in the completed circuit interconnect line. It is noted that the conventional OPC technique such as was employed in connection layout sample pattern 100 is a technique whereby each cell or data file component of the GDS-II data file is post-processed separately for OPC.

Post-processing of the GDS-II format stream data file resulting in a layout pattern that is represented by sample layout pattern 100 (FIG. 1), generated 140 jobs wherein two of the 140 jobs were completed in one hour.

Conventional IC chip CAD layout styles/geometries include a Manhattan layout. The Manhattan technique utilizes rectilinear interconnect lines (or routing channels) as well as X-architecture including diagonal lines/routing channels. The rectilinear lines are formed at 90° to each other (i.e. horizontal and vertical wires, also referred to as wires in the x and y directions). Diagonal wires are utilized to obtain the shortest wire connections between two points when the two points are not in either a horizontal or a vertical position to each other. Typically, a diagonal wire is positioned in a separate IC chip layer. Short line distances are important in order to optimize the operating speed of the chip. Typical Manhattan style reticle diagonal lines have jagged and/or wavy edges because a diagonal line mask is generally formed in x-y lithography steps. Jagged/wavy edges are undesirable because they require more software processing time and result in lines that are not optimized for uniform width. By comparison, rectilinear mask lines are generally straight and have smooth sides. It is known that these conventional techniques for preparing diagonal lines require relatively long processing times, i.e. run-times for fabricating the reticle. Also, these conventional diagonal lines need a significantly greater OPC processing time and data storage compared with rectilinear lines.

With reference to FIGS. 2A and 2B, a conventional OPC post-processing technique was utilized to provide the necessary optical proximity corrections of a conventional X-architecture GDS-II format stream data file (not shown) for fabricating a reticle. As illustrated in FIG. 2A, IC layout sample pattern 200 comprises a graphical representation of an exemplary portion of an IC layout of the GDS-II format stream data file. Layout sample pattern 200 includes diagonally oriented interconnect lines 212, 214, 216, 218, 220, 222, 224 and 226.

Interconnect lines or sections of interconnect lines of a typical X-architecture, such as shown in FIG. 2A, include lines that are at a 90° angle with respect to each other. For example, interconnect lines 216 and 226 as well as the section of line 220 between points 230 and 232 are parallel to the orientation direction of line 224. However, the section of line 220 between points 232 and 234 is oriented perpendicular to line 224. With respect to layout sample pattern 200 (FIG. 2A), the angle of orientation is selected as the angle of orientation between the orientation direction of interconnect line 224 and the x direction. As shown in FIG. 2A, layout sample pattern 200 has a 45° angle of orientation, wherein for example line 224 is in an original orientation position.

The GDS-II stream data file represented by layout sample pattern 200, shown in FIG. 2A, was then corrected by employing a conventional OPC post-processing method, thereby forming an OPC corrected GDS-II format stream data file (not shown). As depicted in FIG. 2B, IC layout sample pattern 240 comprises an exemplary portion of the IC layout pattern (not shown) of the OPC corrected GDS-II data file. It is noted that this OPC post-processing procedure was executed without changing the angle of orientation, i.e. without changing the original orientation position of for example line 224 of layout sample pattern 200. Sample pattern 240 includes OPC post-processed diagonal interconnect lines 242, 244, 246, 248, 250, 252 and 254 corresponding to interconnect lines 212, 214, 216, 218, 220, 222, 224 and 226 respectively of sample pattern 200 shown in FIG. 2A. As illustrated in a comparison between layout sample patterns 200 (FIG. 2A) and 240 (FIG. 2B), OPC post-processing has resulted in typical OPC features such as corner corrections 260, 262, 264, 266, 268 and 270 as well as end of the line corrections 280, 282 and 284.

Conventional OPC post-processing of the GDS-II format stream data file, as illustrated in FIGS. 2A and 2B comprised a data file size of 2 KB prior to OPC post-processing and 423 KB after post-processing. OPC post-processing of this data file required a total of 42 OPC jobs and requiring a processing time of 13 min. 1 sec.

Gabara et al. (U.S. Pat. No. 6,586,281, 2003) disclose a technique for fabricating diagonal lines on a separate reticle that is used for the diagonal lines only. The Gabara teachings execute a series of rotational orientations in order to form a diagonal line at an orientation angle with respect to the x or y direction as follows. The CAD layout is rotated through this orientation angle thereby placing the diagonal line in either the x or y direction. The line is thus positioned as a conventional Manhattan x or y line. The diagonal line pattern is then projected on the reticle blank in the x or y direction. When using the diagonal line for exposure to a photoresist layer, the reticle is positioned at the original orientation angle with respect to the IC chip layer orientation, in order to fabricate the line at the desired orientation.

Conventional OPC post-processing methods are generally useful for preparing mask data files, but even the automated techniques are known to be very time consuming, thereby adding to the manufacturing cost of IC chips and adding to the development and/or manufacturing time, and in some cases providing a limitation to designing the most effective circuits. Accordingly the need exists for improved post-processing techniques in the preparation of mask layout data files, to substantially reduce or overcome the shortcomings of conventional post-processing techniques.

### SUMMARY OF THE INVENTION

In one embodiment of the present invention an integrated circuit data file includes first cells such that each of the first cells comprises one or more first cell data file components and one or more first cell proximity layout patterns. Second cells are then selected from the first cells such that each of the second cells include identical second cell data file components and identical second cell proximity layout patterns. A partitioned identical cell group is then formed. This partitioned identical cell group includes the second cells. Subsequently, the partitioned second cells are subjected to OPC post-processing. Additionally, any other cells of the stream data file can be subjected to the same OPC post-processing technique in one or more processing steps that are separate from the OPC post-processing of the partitioned identical cells.

In another embodiment of the present invention an integrated circuit data file includes at least a first interconnect line that is oriented diagonally in an original orientation position with respect to, for example, the x direction of conventional chip layout x and y directions. The data file is then rotated through an angle of rotation in order to orient the first line in a rectilinear orientation. For example, the data file can be rotated such that the first line is oriented at a 90° angle with respect to the x direction. While in the rotated rectilinear orientation, the first line is subjected to OPC post-processing using OPC post-processing methods for rectilinear IC layout features. Thereafter, the data file including the post-processed first line is rotated to return the first line to the original orientation position.

### BRIEF DESCRIPTION OF THE DRAWINGS

FIG. 1 is a schematic plan illustrating a conventional OPC post-processed IC layout sample.

FIGS. 2A and 2B are schematic plan views illustrating a conventional OPC post-processing sequence.

FIG. 3 is a schematic flow chart illustrating an embodiment of the present invention for an OPC post-processing sequence.

FIGS. 4A-4C are schematic plan views illustrating an embodiment of IC circuit layout sample patterns of the present invention at sequential stages.

FIGS. 5A-5D are schematic plan views illustrating an embodiment of IC circuit layout sample patterns of the present invention at sequential stages.

### DETAILED DESCRIPTION OF TH INVENTION

While describing the invention and its embodiments, certain terminology will be utilized for the sake of clarity. It is intended that such terminology includes the recited embodiments as well as all equivalents.

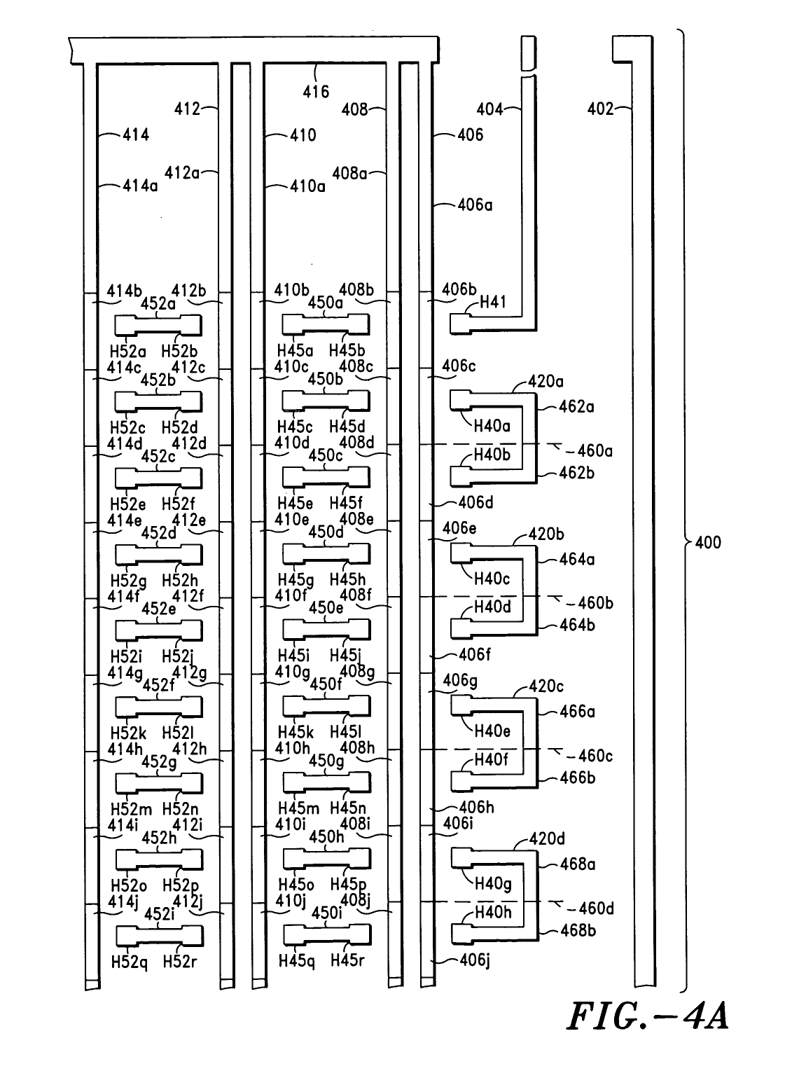

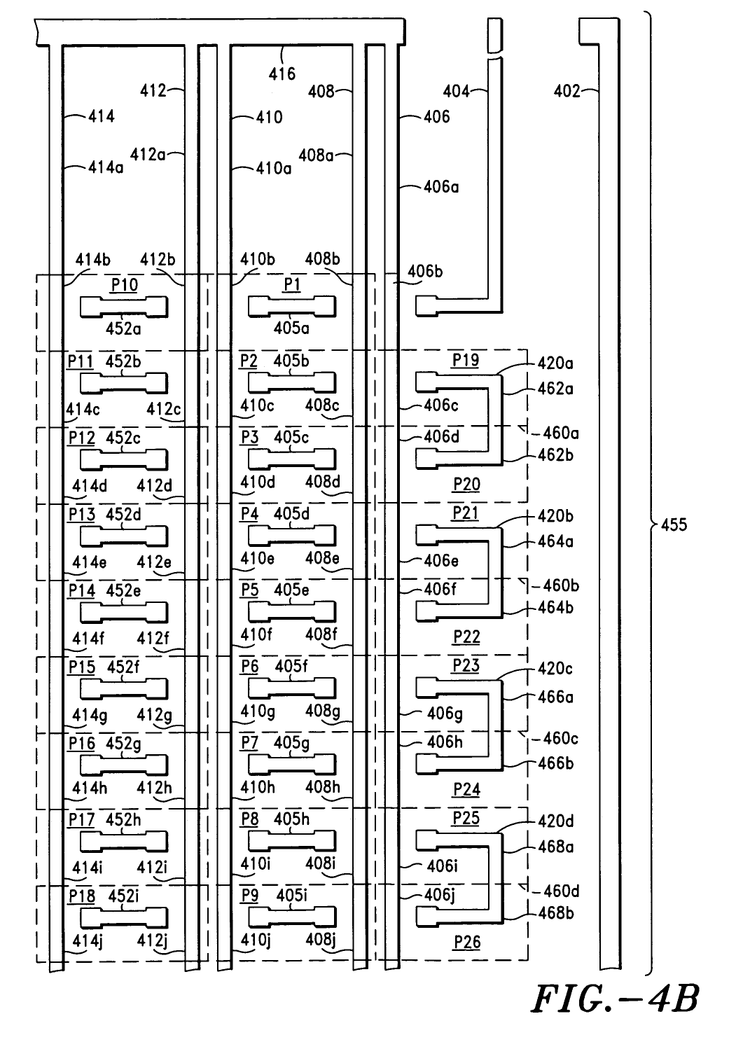

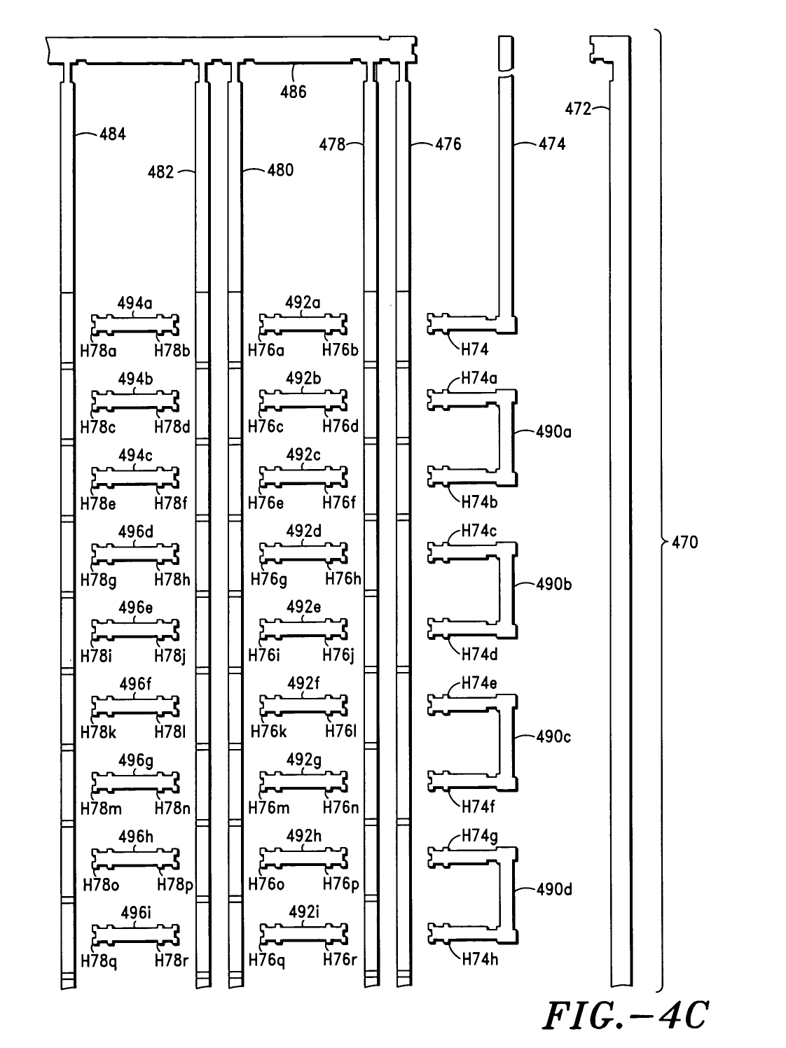

One embodiment of the present invention shown in FIG. 3 illustrating a flow chart 300 starting at step 302 and selecting a GDS-II format IC stream data file for fabricating a reticle at step 304. For example selecting a conventional GDS-II format stream data file for a specific IC chip layer using circuit geometries that are rectilinear. This is followed by executing global partitioning post-processing step 306 of the present invention, as will be more fully described and illustrated in connection with FIGS. 4A-4C. Thereafter, in step 308 of flow chart 300 (FIG. 3), the process is continued by selecting a partitioned group according to methods of the present invention and then in step 310 executing conventional OPC of the selected partitioned group. Step 312 is subsequently employed for determining the run time of the OPC post-processed member, after which the process is ended at step 314. Alternatively, a different OPC procedure can be executed at step 310 if the run time is concluded to be unacceptable.

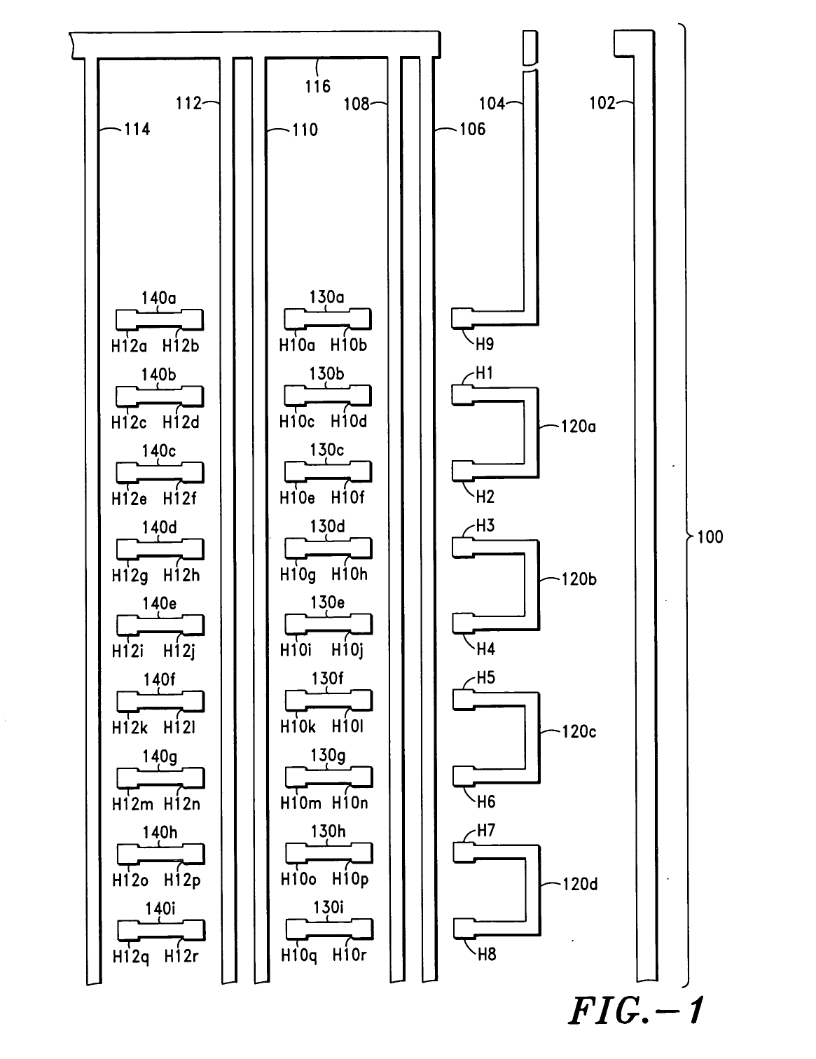

Another embodiment of the present invention shown in FIGS. 4A-4C, illustrates a novel OPC post-processing method of the same GDS-II format stream data file that was described and illustrated in connection with IC layout sample pattern 100, shown in FIG. 1. With reference to flow chart 300 (FIG. 3) and IC layout sample pattern 400 (FIG. 4A), the GDS-II format stream data file was partitioned using global partitioning methods of the present invention, to form partitioned identical cell groups. The expression “partitioned identical cell group” as used herein means a partitioned group of cells, wherein all cells of the partitioned group have identical cell data file components and identical cell proximity layout patterns, as will be described more fully in connection with FIG. 4B and Tables C and D. A “cell” as understood in the context of the present invention means a GDS-II format data file component of a GDS-II format data file for fabricating a reticle, these cells can include one or more cells that are incorporated from a conventional GDS-II format data file library. Methods for forming a group of cells are known to a person of ordinary skill in the art. It will be understood that a typical GDS-II format stream data file of the present invention for fabricating a reticle includes cells that are partitioned in one or more partitioned identical cell groups as well as cells or data file components that are not included in a partitioned group, as will be described in more detail in connection with layout sample 400, shown in FIG. 4A. The expression “global partitioning” as understood in the context of the present invention means partitioning of cells throughout substantially the entire GDS-II format stream data file as well as partitioning of cells in a segment of the GDS-II format stream data file.

Following global partitioning of the present invention, the partitioned GDS-II format stream data file was subjected to OPC post-processing using the same OPC methods as were employed in connection with layout sample pattern 100 (FIG. 1). However, unlike conventional OPC post-processing treatment, OPC post-processing of the present invention involves OPC treatment of the partitioned identical cell groups. OPC post-processing of a partitioned identical cell group includes executing the same proximity corrections for each of the identical cells of the group. In other words, once the OPC corrections of one member of a group have been determined, the process can be executed for all members of the group by just applying the same corrections, because each cell of a partitioned identical cell group is identical to all cells of the group. Cells or data file components that are not included in a partitioned group were post-processed for OPC in the conventional manner.

With reference to FIG. 4A a novel OPC post-processed layout sample pattern 400 is substantially the same as layout sample pattern 100 depicted in FIG. 1, showing a schematic representation of an exemplary portion of the GDS-II format stream data file. Returning to FIG. 4A, layout sample pattern 400 includes typical interconnect lines such as power line 402 and signal lines 404, 406, 408, 410, 412, 414 and 416. As shown in Table A, the data files of signal lines 406, 408, 410, 412 and 414 are partitioned in signal line data file segments.

TABLE A

| Signal Line | Signal line data file segment | | | | | | | | | |
|---|---|---|---|---|---|---|---|---|---|---|
| 406 | 406a | 406b | 406c | 406d | 406e | 406f | 406g | 406h | 406i | 406j |
| 408 | 408a | 408b | 408c | 408d | 408e | 408f | 408g | 408h | 408i | 408j |
| 410 | 410a | 410b | 410c | 410d | 410e | 410f | 410g | 410h | 410i | 410j |
| 412 | 412a | 412b | 412c | 412d | 412e | 412f | 412g | 412h | 412i | 412j |
| 414 | 414a | 414b | 414c | 414d | 414e | 414f | 414g | 414h | 414i | 414j |

Additional interconnect lines include lines 420a, 420b, 420c and 420d, having conventional hammerheads H40a, H40b, H40c, H40d, H40e, H40f, H40g and H40h respectively. Interconnect line 404 includes a conventional hammerhead H41.

As shown in FIG. 4A, layout sample pattern 400 comprises additional interconnect lines 450a, 450b, 450c, 450d, 450e, 450f, 450g, 450h and 450i, as well as interconnect lines 452a, 452b, 452c, 452d, 452e, 452f, 452g, 452h and 452i, each having the same length and the same width. Interconnect lines 450a-450i and 452a-452i include conventional hammerheads as shown in Table B.

TABLE B

| Signal line | Hammerheads |
|---|---|
| 450a | H45a, H45b |
| 450b | H45c, H45d |
| 450c | H45e, H45f |
| 450d | H45g, H45h |
| 450e | H45i, H45j |
| 450f | H45k, H45l |
| 450g | H45m, H45n |
| 450h | H45o, H45p |
| 450i | H45q, H45r |
| 452a | H52a, H52b |
| 452b | H52c, H52d |
| 452c | H52e, H52f |
| 452d | H52g, H52h |
| 452e | H52i, H52j |
| 452f | H52k, H52l |
| 452g | H52m, H52n |
| 452h | H52o, H52p |
| 452i | H52q, H52r |

Hammerheads H40a-H40h, H41, H45a-H45r and H52a-H52r, shown in FIG. 4A, are formed as a result of OPC post-processing.

As shown in FIG. 4B and Table C, layout sample pattern 455 includes GDS-II format data file cells P1-P18. These cells include cell data file components comprising interconnect lines 450a-450i and 452a-452i each having the same length and the same width. Data file cells P1-P18 further include signal line segments 408b-408j, 410b-410j, 412b-412j and 414b-414j each having the same length and the same width.

TABLE C

CELL DATA
FILE COMPONENT

| | Interconnect | Signal line |
|---|---|---|
| CELL | line | segment |
| P1 | 450a | 408b, 410b |
| P2 | 450b | 408c, 410c |
| P3 | 450c | 408d, 410d |
| P4 | 450d | 408e, 410e |
| P5 | 450e | 408f, 410f |
| P6 | 450f | 408g, 410g |
| P7 | 450g | 408h, 410h |
| P8 | 450h | 408i, 410i |
| P9 | 450i | 408j, 410j |
| P10 | 452a | 412b, 414b |
| P11 | 452b | 412c, 414c |
| P12 | 452c | 412d, 414d |
| P13 | 452d | 412e, 414e |
| P14 | 452e | 412f, 414f |
| P15 | 452f | 412g, 414g |
| P16 | 452g | 412h, 414h |
| P17 | 452h | 412i, 414i |
| P18 | 452i | 412j, 414j |

Regarding interconnect lines 450a-450i and 452a-452i, it is noted that each of these interconnect lines is positioned centrally with respect to the signal line segments of the respective cells. However, it will be understood that the scope of the present invention is not limited to cells wherein a signal line is positioned centrally with regard to one or more signal line segments.

A review of Table C and FIG. 4B shows that cells P1-P18 have identical data file layout components comprising interconnect lines and interconnect line segments. It is also noted that the interconnect lines that are tabulated in Table C are positioned such that the distance between the interconnect line and the respective line segments, is the same in each of cells P1-P18.

As schematically depicted in FIG. 4B, cells P1-P18 are positioned in IC layout sample pattern 455 in close proximity to layout patterns that cause proximity effects in these cells. Cell proximity layout patterns of layout cells P1-P8 are tabulated in Table D. The term “cell proximity layout pattern” as used herein means a data file layout pattern that is in close proximity to the cell such that the layout proximity pattern causes a proximity effect on the GDS-II format of the cell data file.

TABLE D

CELL PROXIMITY
LAYOUT
PATTERNS

| LAYOUT | Layout | line 406 | line 412 |
|---|---|---|---|
| CELL | cells | segments | segments |
| P1 | P2 | 406b | 412b |
| P2 | P1, P3 | 406c | 412c |
| P3 | P2, P4 | 406d | 412d |
| P4 | P3, P5 | 406e | 412e |
| P5 | P4, P6 | 406f | 412f |
| P6 | P5, P7 | 406g | 412g |
| P7 | P6, P8 | 406h | 412h |
| P8 | P7, P9 | 406i | 412i |

With reference to Table D it is shown that cells P2-P8 have the same cell proximity layout patterns. As previously described in connection with FIG. 4B and Table C, cells P1-P8 have identical data file layout features. Cells P2-P8 thus have the same data file layout components as well as having the same cell proximity layout patterns. Cells P2-P8 are therefore selected as cells of a partitioned identical cell group in accordance with techniques of the present invention. Layout sample pattern 400 shown in FIG. 4B, does not provide sufficient information to determine whether cell P9 has the same cell proximity layout pattern as cells P2-P8 and, for the purpose of the present example, is therefore not included in the P2-P8 partitioned identical cell group.

Regarding cells P10-P18, layout sample pattern 455 (FIG. 4B) does not provide sufficient information to determine whether cells P11-P17 have the same cell proximity layout patterns. If cells (not shown) identical to cells P10-P18 were positioned adjacent to cells P10-P18 in the same manner as at the way wherein cells P10-P18 are positioned with respect to cells P1-P9, then it is noted by analogy with Table D that cells P 11-P17 would have the same cell proximity layout patterns. These cells also have identical data file layout features, see FIG. 4B and Table C. Cells P11-P17 could then be selected as cells of the same partitioned identical cell group as cells P2-P8.

With respect to cells P1 and P10, it is noted that these cells would be selected as cells of the same partitioned identical cell group if an additional cell (not shown), identical to cell P10 were positioned adjacent to cell P10 in the same manner as the way in which cell P10 is positioned with respect to cell P1, since cells P1 and P10 would then have the same data file layout features and the same cell proximity layout pattern.

Employing methods of the present invention, cells P2-P8 were subjected to OPC post-processing as identical cells since these cells are cells of a partitioned identical cell group, resulting in hammerheads as shown in FIG. 4B and tabulated in Table B.

Regarding interconnect lines 420a, 420b, 420c and 420d of layout sample patterns 400 and 455 (FIGS. 4A and 4B respectively) it is noted that each of these interconnect lines include a plane of symmetry 460a, 460b, 460c and 460d respectively. This plane of symmetry divides data files of each of the interconnect lines in mirror images, each mirror image including an interconnect segment comprising half of the interconnect line. As shown in sample pattern 400, interconnect line 420a comprises interconnect line segments 462a and 462b that are mirror image data file components. Similarly, interconnect lines 420b, 420c and 420d include mirror image data file components 464a, 464b, 466a, 466b, 468a and 468b respectively, see FIG. 4B. The mirror image data files of these line segments each constitute a separate cell such as cells P19-P26 illustrated in FIG. 4B and shown in Table E.

TABLE E

| | Interconnect |
|---|---|
| CELL | line segments |
| P19 | 462a, 406c |
| P20 | 462b, 406d |
| P21 | 464a, 406e |
| P22 | 464b, 406f |
| P23 | 466a, 406g |
| P24 | 466b, 406h |
| P25 | 468a, 406i |
| P26 | 468b, 406j |

With reference to Table E and FIG. 4B, it is known to a person of ordinary skill in the art that cells which are mirror image data files, such as cells P19 and P20, can be subjected to OPC post-processing in the same manner as the way in which identical cells are processed. Cells P19-P26 are therefore considered as identical data file layout components for the purpose of partitioning and OPC post-processing techniques of the present invention. By analogy with the reasoning concerning the cell proximity layout patterns of cells P1-P18 (FIG. 4B and Table D), it is concluded that cells P19-P25 have the same cell proximity layout patterns. Cells P19-P25 are therefore selected as cells of a partitioned identical cell group, and are subjected to OPC post-processing as identical cells similar to the OPC post-processing as described in connection with cells P2-P8.

The hammerheads that are formed in layout sample patterns 400 and 455, shown in FIGS. 4A and 4B respectively, are formed through OPC post-processing of the partitioned GDS-II format stream data file, i.e. the GDS-II format data file that includes the partitioned identical cell groups. As described above, novel OPC post-processing of the GDS-II format data file includes OPC post-processing of partitioned cells as well as non-partitioned cells and data file components. OPC features such as hammerheads are thus formed in partitioned identical cell groups as well as in cells that are not partitioned such as line 404.

OPC post-processing that resulted in layout pattern 400 (FIG. 4A) generated only one OPC job which was completed in 33 minutes. This is compared with the conventional OPC post-processing technique, described in connection with FIG. 1, which generated 140 jobs wherein two of the jobs were completed in one hour. The techniques of the present invention thus resulted in a much shorter OPC post-processing time then the conventional method.

Subsequently, model based OPC for 193 nm high NA scanner was executed as illustrated in IC layout sample pattern 470 depicted in FIG. 4C. Layout sample pattern 470 includes interconnect lines 472, 474, 476, 478, 480, 482, 484, 486, 490a-490d, 492a-492i and 494a-494i, corresponding to interconnect lines 402, 404, 406, 408, 410, 412, 414, 416, 420a-420d, 430a-430i and 440a-440i respectively of layout sample pattern 400 depicted in FIG. 4A.

TABLE F

| Signal line | Hammerheads |
|---|---|
| 474 | H74 |
| 490a | H74a, H74b |
| 490b | H74c, H74d |
| 490c | H74e, H74f |
| 490d | H74g, H74h |
| 492a | H76a, H76b |
| 492b | H76c, H76d |
| 492c | H76e, H76f |
| 492d | H76g, H76h |
| 492e | H76i, H76j |
| 492f | H76k, H76l |
| 492g | H76m, H76n |
| 492h | H76o, H76p |
| 492i | H76p, H76r |
| 494a | H78a, H78b |
| 494b | H78c, H78d |
| 494c | H78e, H78f |
| 494d | H78g, H78h |
| 494e | H78i, H78j |
| 494f | H78k, H78l |
| 494g | H78m, H78n |
| 494h | H78o, H78p |
| 494i | H78q, H78r |

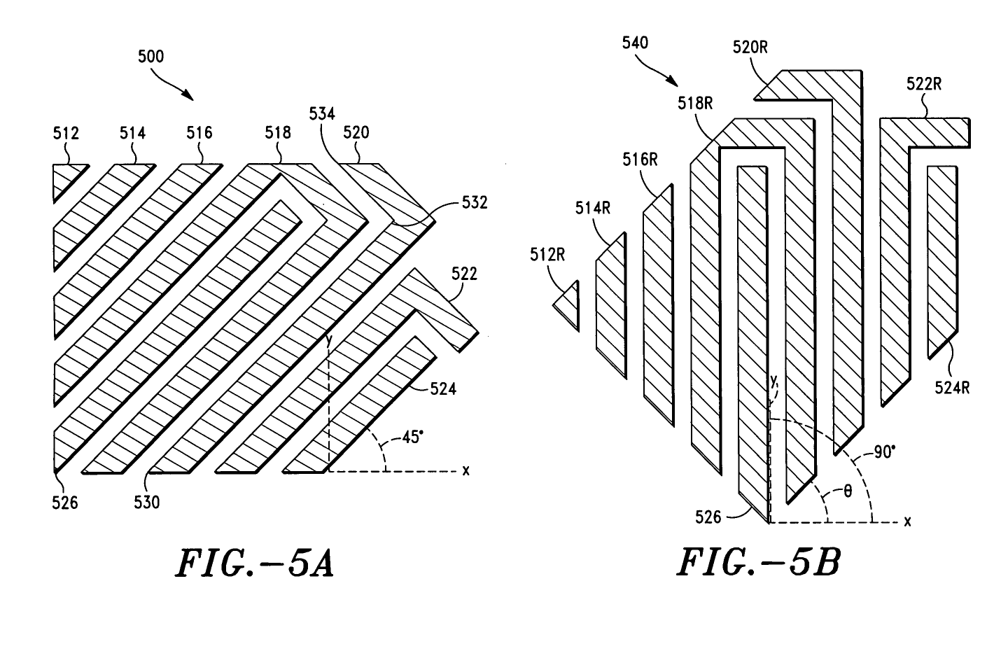

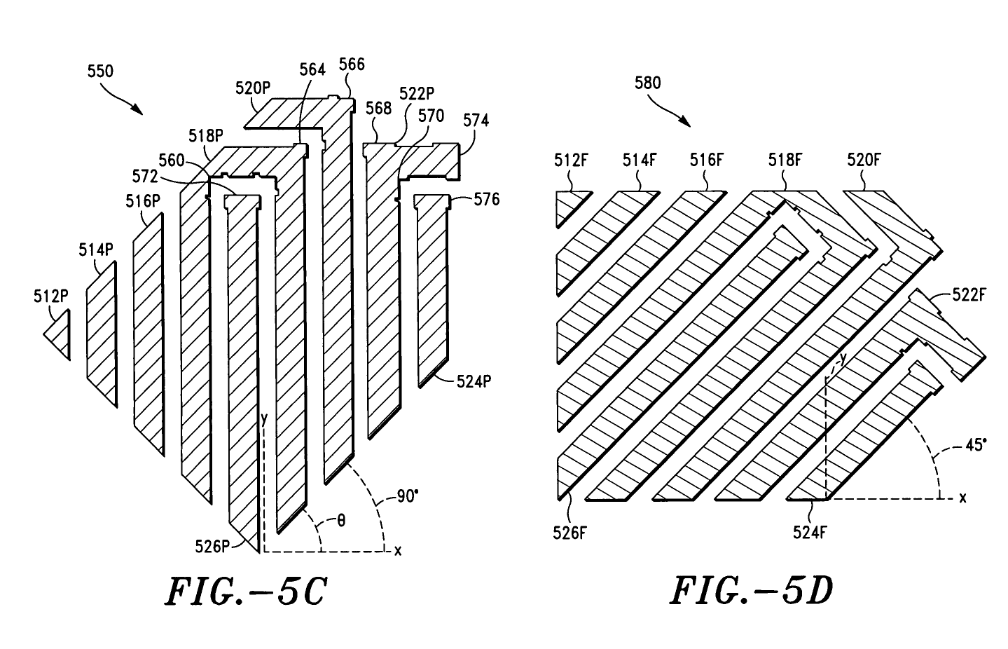

In an additional embodiment of the present invention, the novel post-layout processing methods also include methods for designing reticle mask layout data files using X-architecture layout techniques wherein diagonal interconnect lines are utilized, as schematically illustrated and described in connection with the processing sequence shown in FIGS. 5A-5C.

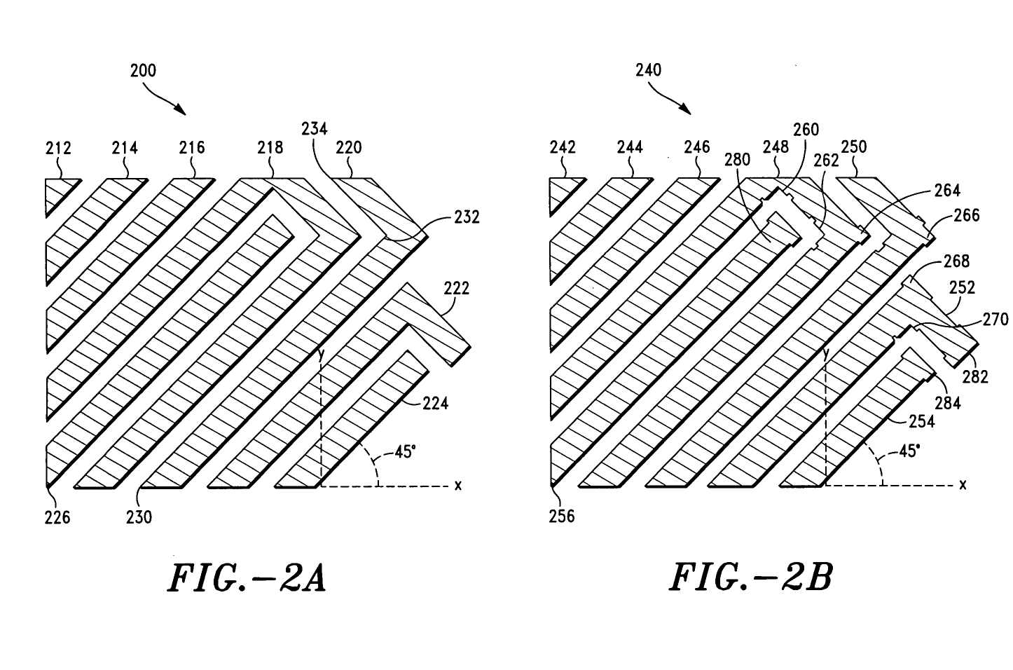

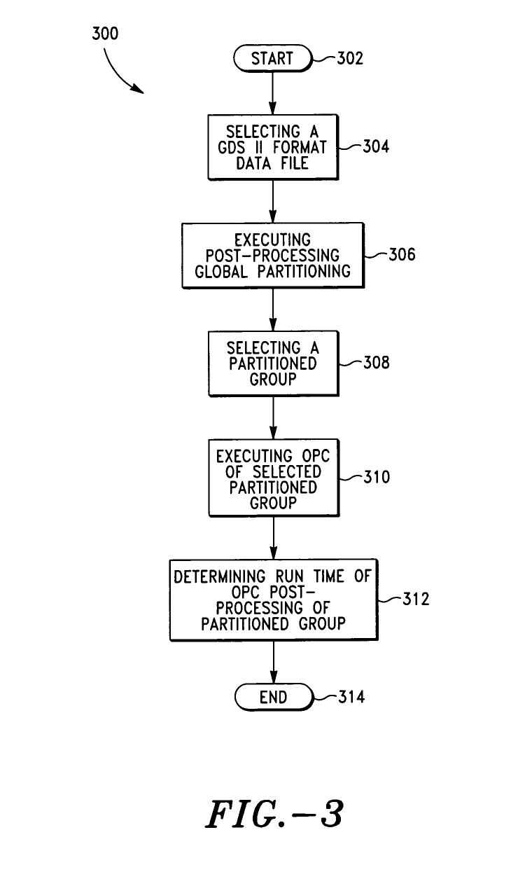

With reference to FIG. 5A, IC layout sample pattern 500 comprises a graphical representation of an exemplary portion of a conventional GDS-II format stream data file for fabricating a reticle (not shown). Sample pattern 500 includes interconnect lines 512, 514, 516, 518, 520, 522, 524 and 526. These interconnect lines are formed using the same GDS-II format stream data file as sample pattern 200 shown in FIG. 2A, and they have the same 45° orientation angle with respect to the x direction. Sample pattern 500 (FIG. 5A) includes parallel interconnect lines 514, 516, 524 and 526, as well as the section of interconnect line 520 between points 530 and 532, which are oriented at a 45° angle, wherein the orientation of lines 514, 516, 524 and 526 is designated as the original orientation position of these lines. It is noted that, for example, the section of line 520 between points 534 and 532 is oriented perpendicular to the orientation position of lines 514, 516, 524 and 526. Sample pattern 500 including interconnect lines 512, 514, 516, 518, 520, 522, 524 and 526, schematically shown in FIG. 5A, is thus the same as sample pattern 200 including interconnect lines 212, 214, 216, 218, 220, 222, 224 and 226 respectively, see FIG. 2A.

Employing conventional computer programs the GDS-II format stream data file of sample pattern 500, see FIG. 5A, was rotated through an angle of rotation θ wherein θ=45°, resulting in a rotated GDS-II format stream data file schematically shown in IC layout sample pattern 540 depicted in FIG. 5B. Interconnect lines 512R, 514R, 516R, 518R, 520R, 522R, 524R and 526R of sample layout 540 are the same interconnect lines as lines 512, 514, 516, 518, 520, 522, 524 and 526 respectively of sample pattern 500 illustrated in FIG. 5A, except that the interconnect lines of layout sample 540 (FIG. 5B) are oriented in a rectilinear orientation as a result of the rotation at angle θ=45°. For example lines 514R, 516R, 524R and 526R are oriented at a 90° angle with respect to the x orientation direction.

With reference to FIG. 5C, the rotated GDS-II format data file of layout sample pattern 540, i.e. the data file that has been rotated at θ=45°, is then subjected to the same conventional OPC post-processing method as was used in connection with layout sample patterns 200 (FIG. 2A) and 240 (FIG. 2B). OPC post-processing of IC sample layout pattern 540 resulted in IC layout sample pattern 550 depicted in FIG. 5C. Layout sample pattern 550 includes interconnect lines 512P, 514P, 516P, 518P, 520P, 522P, 524P and 526P. With reference to FIG. 5C, it is noted that OPC post-processing has resulted in OPC features such as corner corrections 560, 562, 564, 566, 568 and 570 as well as end of the line corrections 572, 574 and 576. These OPC correction features are similar to the OPC correction features that are formed in layout sample pattern 240 shown in FIG. 2B. Finally, the rotated GDS-II format stream data file of sample pattern 550 is rotated through the angle of rotation, i.e. θ=45°, thus forming IC layout sample pattern 580 wherein interconnect lines 512F, 514F, 516F, 518F, 520F, 522F, 524F and 526F have been returned to the original 45° orientation angle, i.e. the original orientation position if these lines prior to OPC post-processing, while retaining the OPC features that were obtained through the novel post-processing methods of the present invention.

Employing the methods as described and illustrated in connection with sample patterns 500 (FIG. 5A), 540 (FIG. 5B), 550 (FIG. 5C) and 580 (FIG. 5D) conducting OPC post-processing of diagonal interconnect lines wherein the size of the mask layout data file comprised 2 KB prior to OPC and 76 KB after OPC, and performing a total of 6 OPC jobs in 1 min 28 sec. As described in connection with sample patterns 200 (FIG. 2A) and 240 (FIG. 2B), conventional OPC post-processing required a total of 42 OPC jobs in 13 min. 1 sec and required a 423 KB data file after OPC post-processing. The inventive method thus achieved the same results approximately 9 times faster than the conventional method, while using a DB that was approximately 15% of the DB size of the conventional OPC post-processing technique without rotating the data file.

It is noted that techniques of the present invention have employed layout data files wherein interconnect lines are positioned at an original angle of orientation of 45° with respect to for example the x direction of typical x and y directions of a GDS-II format data file. However, the invention is equally operable when other angles of orientation are employed, such as 22.5°, 30° and 60°, provided that the sum of the angle of rotation and the original angle of orientation equals 90° in order to rotate the data file into a position wherein the interconnect lines are positioned for OPC post-processing in alignment with the x and y directions.

The invention as described in connection with IC layout sample patterns 500 (FIG. 5A), 540 (FIG. 5B), 550 (FIG. 5C) and 580 (FIG. 5D) employed a mask data file such as pattern 500 that was post-processed using conventional OPC post-processing methods. However, the invention is equally operable when OPC post-processing techniques of the present invention are used by employing global partitioning as illustrated and described in connection with flow chart 300 (FIG. 3), and sample patterns 400 and 455 (FIGS. 4A and 4B respectively).

Data files of the present invention for reticle or mask fabrication, have been illustrated herein by using conventional GDS-II format stream data files. However, the invention is similarly operable when using data file formats other than GDS-II format stream data files. Reticle or mask fabrication methods have been illustrated herein for the fabrication of interconnect lines. However the invention is equally operable for the fabrication of vias, electrical contacts such as bond pads, and gate electrodes for transistors.

The invention has been described in terms of exemplary embodiments of the invention. One skilled in the art will recognize that it would be possible to construct the elements of the present invention from a variety of means and to modify the placement of components in a variety of ways. While the embodiments of the invention have been described in detail and shown in the accompanying drawings, it will be evident that various further modifications are possible without departing from the scope of the invention as set forth in the following claims.

We claim:

1. A method of post-processing an integrated circuit data file, the method comprising:
a) selecting the integrated circuit data file, wherein the data file includes first cells;
b) selecting second cells from the first cells, such that all second cells are identical;
c) employing the second cells for forming a partitioned cell group;
d) selecting an OPC method for post-processing; and
e) employing the selected OPC method for post-processing the second cells.

2. A method of post-processing an integrated circuit data file, the method comprising:
a) selecting the integrated circuit data file, wherein the data file includes first cells, such that each of the first cells comprises (1) one or more first cell data file components and (2) one or more first cell proximity layout patterns;
b) employing the first cells for selecting second cells such that all of the second cells include (1) identical second cell data file components and (2) identical second cell proximity layout patterns;
c) forming a first partitioned identical cell group comprising the second cells;
d) selecting an OPC method for post-processing; and
e) employing the selected OPC method for post-processing the second cells.

3. The method of claim 2 wherein second cell proximity patterns comprise data file layout patterns that are in close proximity to the second cell such that the proximity patterns cause one or more proximity effects on the integrated circuit data file of the second cell.

4. The method of claim 2 wherein the second cells each comprise data including at least a first interconnect line data file component.

5. The method of claim 4 wherein the second cells each additionally comprise at least a first interconnect line segment data file.

6. The method of claim 2 wherein the second cells each comprise data selected from the group consisting of one or more data files for fabricating electrical contacts, vias and gate electrodes for transistors.

7. The method of claim 2 wherein the data file includes third cells having third cell proximity layout patterns that are not identical to the second cell proximity layout patterns.

8. The method of claim 7 additionally comprising employing the selected OPC method for post-processing the third cells.

9. The method of claim 2 additionally comprising forming a second partitioned identical cell group comprising third cells, wherein each of the third cells comprise (1) identical third cell data file components and (2) identical third cell proximity layout patterns.

10. The method of claim 9 additionally comprising employing the selected OPC method for post-processing the third cells.

11. The method of claim 2 wherein the integrated circuit data file comprises an integrated circuit GDS-II format stream data file.

12. The method of claim 2 wherein the selected OPC method is selected from the group consisting of model-based OPC and rule-based OPC.

13. The method of claim 2 wherein forming a first partitioned identical cell group additionally comprises utilizing global partitioning.

14. A method of post-processing an integrated circuit data file, the method comprising:
a) selecting the integrated data file wherein the data file comprises first cells for fabricating interconnect lines, such that the first cells comprise second cells for fabricating interconnect lines having a plane of symmetry;
b) utilizing the second cells for forming mirror image data files;
c) employing the mirror image data files for selecting third cells such that all of the third cells include (1) identical third cell data file components and (2) identical third cell proximity layout patterns;
d) forming a partitioned identical cell group comprising the third cells;
e) selecting an OPC method for OPC post-processing; and
f) employing the selected OPC method for post-processing the third cells.

15. A method of fabricating an integrated circuit reticle, the method comprising:
a) forming an integrated circuit data file of the integrated circuit, wherein the data file includes first cells;
b) selecting second cells from the first cells, such that all second cells are identical;
c) selecting third cells from the first cells, wherein the third cells comprise all first cells that are not selected as second cells;
d) employing the second cells for forming a partitioned identical second cell group including second cells;
e) selecting an OPC method for post-processing;
f) employing the selected OPC method for post-processing the second cells that are included in the partitioned identical second cell group, thereby forming post-processed second cells;
g) employing the selected OPC method for post-processing the third cells, thereby forming post-processed third cells; and
h) utilizing the post-processed second cells and the post-processed third cells for fabricating the integrated circuit reticle.

16. The method of claim 15 wherein the data file comprises a GDS-II format stream data file.

17. The reticle fabricated according to the method of claim 15.

18. A method of post-processing an integrated circuit data file including at least a first interconnect line pattern for fabricating an at least first interconnect line, such that the at least first interconnect line is oriented at an original orientation angle, in an original orientation position that is diagonal with respect to x and y integrated circuit layout directions, the method comprising:
a) rotating the data file through a rotation angle in order to orient the at least first interconnect line pattern rectilinear with respect to the x and y directions, wherein a rotated data file is formed;
b) executing OPC post-processing of the at least first interconnect line pattern of the rotated data file, thus forming a post-processed rotated data file; and
c) rotating the post-processed rotated data file through the rotation angle to orient the at least first interconnect line in the original orientation position.

19. The method of claim 18, wherein the sum of the original orientation angle and the rotation angle is substantially equal to 90°.

20. The method of claim 18 wherein the integrated circuit data file comprises a GDS-II format stream data file.

21. The method of claim 18 additionally comprising a second interconnect line pattern for fabricating an at least second interconnect line such that the at least second interconnect line is oriented at an angle of 90° with respect to the at least first interconnect line.

22. The method of claim 21 additionally comprising executing OPC post-processing of the at least second interconnect line pattern when the at least first line pattern is oriented rectilinear with respect to the x and y directions.

23. A method of post-processing an integrated circuit data file including at least a first interconnect line pattern for fabricating an at least first interconnect line, such that the at least first interconnect line is positioned at an original orientation angle in an original orientation position that is diagonal with respect to x and y integrated circuit layout directions, the method comprising:
a) selecting the data file;
b) selecting the at least first interconnect line pattern;
c) determining (1) the original orientation angle and (2) the original orientation position between the at least first interconnect line pattern and the x direction;
d) forming a rotated data file by rotating the data file through a rotation angle in order to orient the at least first interconnect line pattern rectilinear with respect to the x and y directions, wherein the sum of the original orientation angle and the rotation angle is substantially equal to 90°;
e) selecting an OPC method for post-processing;
f) forming a post-processed rotated data file by employing the selected OPC method for post-processing of the at least first interconnect line pattern of the rotated data file; and
g) rotating the post-processed rotated data file through the rotation angle, in order to orient the at least first interconnect line pattern in the original orientation position.

24. The method of claim 23 wherein the original orientation angle is 45°.

25. The method of claim 23 wherein the original orientation angle is selected from the group consisting of 22.5°, 30° and 60°.

26. The method of claim 23 wherein the OPC method is selected from the group consisting of rule-based OPC and model-based OPC.

27. A method of post-processing an integrated circuit data file including a plurality of parallel interconnect line patterns for fabricating parallel interconnect lines and including parallel interconnect line cells, wherein the interconnect lines are oriented in an original orientation position that is diagonal with x and y integrated circuit layout positions, the method comprising:
a) rotating the data file through a rotation angle in order to orient the parallel interconnect lines rectilinear with respect to the x and y directions, wherein a rotated data file is formed;
b) selecting identical cells from the parallel interconnect line cells in the rotated data file;
c) employing the identical cells for forming a partitioned identical cell group;
d) selecting an OPC method;
e) utilizing the OPC method for post-processing the partitioned identical cells, thereby forming a post-processed rotated data file; and
f) rotating the post-processed rotated data file through the rotation angle in order to orient the parallel interconnect lines in the original orientation position.
